(19) United States
(12) Patent Application Publication
(10) Pub. No.: US 2013/0148070 A1
(43) Pub. Date: Jun. 13, 2013

(54) PARALLAX BARRIER FOR DISPLAYING 3D IMAGE AND DISPLAY DEVICE USING THE SAME

(71) Applicants: Tae Ho KIM, Asan-si (KR); Seong Nam LEE, Seoul (KR); Jung-Hun LEE, Seoul (KR); Seung Beom PARK, Seoul (KR); Duck Jong SUH, Seoul (KR)

(72) Inventors: Tae Ho KIM, Asan-si (KR); Seong Nam LEE, Seoul (KR); Jung-Hun LEE, Seoul (KR); Seung Beom PARK, Seoul (KR); Duck Jong SUH, Seoul (KR)

(73) Assignee: SAMSUNG DISPLAY CO., LTD., Yongin-City (KR)

(21) Appl. No.: 13/483,108

(22) Filed: May 30, 2012

(30) Foreign Application Priority Data
Dec. 8, 2011 (KR) 10-2011-0130886

(51) Int. Cl. G02F 1/1343

(52) U.S. Cl. 349/143

(57) ABSTRACT

A parallax barrier for a 3D image display includes a first substrate; and a second substrate opposite to the first substrate, a first gap control electrode disposed on the first substrate, a first passivation layer disposed on the first gap control electrode, a liquid crystal control electrode disposed on the first passivation layer, an opposing electrode disposed on the second substrate, and a liquid crystal layer interposed between the first substrate and the second substrate, where the liquid crystal control electrode includes a plurality of unit liquid crystal control electrodes, where two neighboring unit liquid crystal control electrodes are spaced apart with a gap, and where the first gap control electrode overlaps the gap between the unit liquid crystal control electrodes.

This application claims priority to Korean Patent Application No. 10-2011-0130886, filed on Dec. 08, 2011, and all the benefits accruing therefrom under 35 U.S.C. §119, the content of which in its entirety is herein incorporated by reference.

### BACKGROUND OF THE INVENTION

(a) Field of the Invention

Exemplary embodiments of the invention relate to a parallax barrier for a three-dimensional (“3D”) image display and a display device including the parallax barrier, and more particularly, a parallax barrier for a 3D image display including a liquid crystal and a two-dimensional (“2D”)/3D switchable image display device including the parallax barrier.

(b) Description of the Related Art

Recently, a 3D stereoscopic image display device has been widely used and various 3D image display methods have been researched.

One of methods that are most widely used in displaying a stereoscopic image is a method using the binocular disparity. In the method using the binocular disparity, an image that reaches a left eye and an image that reaches a right eye are displayed by a same display device, and the two images are delivered to the left eye and the right eye of an observer. In the method using the binocular disparity, images observed at different angles are delivered to the left and right eyes to allow the observer to perceive a 3D effect.

In the method using the binocular disparity, a method of transmitting the left eye and right eye images into the left eye and the right eye includes a method using spectacles and an autostereoscopy method. The autostereoscopy method includes a parallax barrier method and a lenticular lens.

In the parallax barrier method, the display device alternately displays a left eye image and a right eye image in a horizontal direction, and a parallax barrier is positioned in front of the display device. In the parallax barrier, a block portion for blocking light and an opening portion for transmitting light are alternately formed and the image from the display device is divided into a left eye image and a right eye image through the opening portion, and the left eye image and the right eye image are thereby input to the left eye and the right eye of the observer, respectively.

The parallax barrier may include liquid crystal. In the parallax barrier including liquid crystal the parallax barrier may be turned on and off by applying a voltage to an electrode for controlling the liquid crystal to turned on and off. In the parallax barrier including the liquid crystal, a plurality of control electrodes may be used to form the block portion and the opening portion, which are be formed by controlling alignment of the liquid crystal.

### BRIEF SUMMARY OF THE INVENTION

Exemplary embodiments of the invention relate to a parallax barrier for a three-dimensional (“3D”) image display with reduced front crosstalk and a display device including the parallax barrier.

An exemplary embodiment of a parallax barrier for a 3D image display includes: a first substrate; and a second substrate opposite to the first substrate; a first gap control electrode disposed on the first substrate; a first passivation layer disposed on the first gap control electrode; a liquid crystal control electrode disposed on the first passivation layer; an opposing electrode disposed on the second substrate; and a liquid crystal layer interposed between the first substrate and the second substrate, where the liquid crystal control electrode includes a plurality of unit liquid crystal control electrodes, where two neighboring unit liquid crystal control electrodes are spaced apart with a gap, and where the first gap control electrode overlaps the gap between the unit liquid crystal control electrodes.

An exemplary embodiment of a display device includes the parallax barrier for the 3D image display and a display panel.

In an exemplary embodiment, at least a portion of the first the gap control electrode and at a least portion of the opposing electrode may be applied with different voltages such that a block portion is formed in the liquid crystal layer corresponding to the gap between the unit liquid crystal control electrodes.

In an exemplary embodiment, the first gap control electrode may include a plurality of unit gap control electrodes, two neighboring unit gap control electrodes may be spaced apart from each other, and each of the plurality of unit gap control electrodes may overlap the gap between two corresponding unit liquid crystal control electrodes.

In an exemplary embodiment, a voltage applied to a portion of the unit gap control electrodes may be substantially the same as a voltage applied to the opposing electrode.

In an exemplary embodiment, the opposing electrode may include a plurality of unit opposing electrodes, two neighboring unit opposing electrodes may be spaced apart from each other with a gap, and each of the unit opposing electrodes may overlap both of two corresponding unit liquid crystal control electrodes.

In an exemplary embodiment, the parallax barrier of the 3D image display may further include a second gap control electrode disposed between the second substrate and the opposing electrode.

In an exemplary embodiment, at least a portion of the second gap control electrode and at least a portion of the unit liquid crystal control electrodes may be applied with different voltages such that the block portion is formed in the liquid crystal layer corresponding to the gap between the unit opposing electrodes.

In an exemplary embodiment, two neighboring unit liquid crystal control electrodes may be applied with different voltages such that the liquid crystal layer corresponding to one of the two neighboring unit liquid crystal control electrodes may form a block portion or an opening portion.

In an exemplary embodiment, at least two neighboring unit liquid crystal control electrodes may be applied with a same voltage such that the liquid crystal layer corresponding to the at the least two neighboring unit liquid crystal control electrodes may form a block portion or an opening portion.

In an exemplary embodiment, the parallax barrier for the 3D image display may further include a sensing unit which senses a position of an observer, where a position of the block portion or a position of the opening portion corresponding to the unit liquid crystal control electrodes may be changed based on the position of the observer sensed by the sensing unit.

According to an exemplary embodiment of the invention, crosstalk between a left eye image and a right eye image is substantially reduced or effectively prevented.

### BRIEF DESCRIPTION OF THE DRAWINGS

The above and other features of the invention will become more apparent by describing in further detail exemplary embodiments thereof with reference to the accompanying drawings, in which:

FIG. 1 is a schematic view showing an exemplary embodiment of a method displaying a three-dimensional (“3D”) image through a display device using a parallax barrier according to the invention;

FIG. 2 is a cross-sectional view of an exemplary embodiment of a parallax barrier according to the invention;

FIG. 3 is a signal timing diagram showing driving signals applied to the parallax barrier shown in FIG. 2;

FIGS. 4A and 4B are cross-sectional views of an exemplary embodiment of a parallax barrier, driven by the driving signals shown in FIG. 3;

FIG. 5 is a graph showing transmittance of the parallax barrier shown in FIG. 2;

FIG. 6 is a cross-sectional view of an exemplary embodiment of a parallax barrier according to the invention;

FIG. 7 is a signal timing diagram showing driving voltages applied to the parallax barrier shown in FIG. 6;

FIG. 8 is a cross-sectional view of the parallax barrier of FIG. 6 in a different state;

FIG. 9 is a signal timing diagram showing driving voltages applied to the parallax barrier shown in FIG. 8;

FIG. 10 is a cross-sectional view of the parallax barrier of FIG. 6 in another different state;

FIG. 11 is a signal timing diagram showing driving voltages applied to the parallax barrier shown in FIG. 10;

FIG. 12 shows a graph showing transmittance of the parallax barrier shown in FIGS. 6, 8 and 10;

FIG. 13 is a cross-sectional view of an alternative exemplary embodiment of a parallax barrier according to the invention;

FIG. 14 is a signal timing diagram showing driving voltages applied to the parallax barrier shown in FIG. 13;

FIG. 15 is a cross-sectional view of another alternative exemplary embodiment of a parallax barrier according to the invention;

FIG. 16 is a signal timing diagram showing driving voltages applied to the parallax barrier shown in FIG. 15;

FIG. 17 is a cross-sectional view of the parallax barrier shown in FIG. 15 in a different state;

FIG. 18 is a signal timing diagram showing driving voltages applied to the parallax barrier shown in FIG. 17; and

FIG. 19 is a graph showing transmittance of the parallax barrier shown in FIG. 17.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

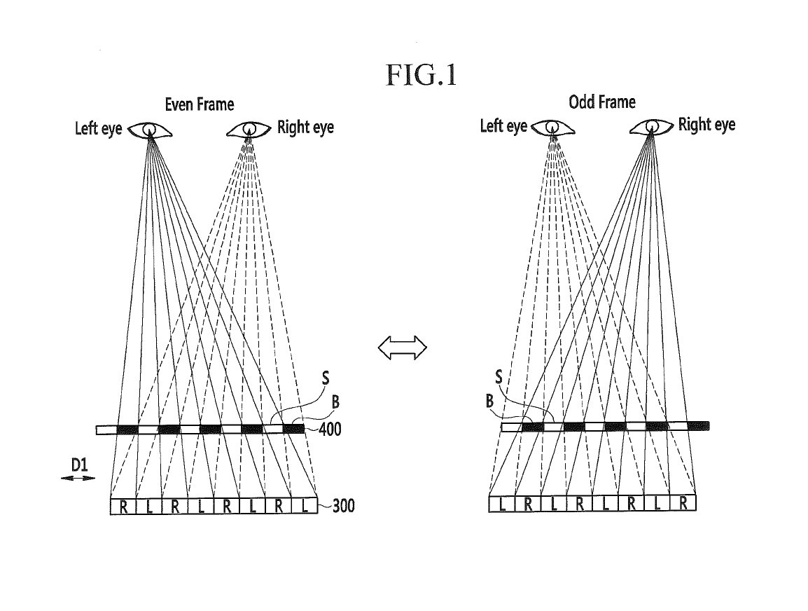

Firstly, an exemplary embodiment of a two-dimensional (“2D”) /three-dimensional (“3D”) switchable 3D image display device according to the invention will be described referring to FIG. 1.

FIG. 1 is a view of a 3D image displayed by a display device using a parallax barrier according to the invention.

An exemplary embodiment of a display device using a parallax barrier for a 3D image display (referring to a parallax barrier) includes a display panel 300 for displaying images and a parallax barrier 400 positioned in front of a screen for displaying the images of the display panel 300.

The display panel 300 may be one of various display devices, such as a plasma display device (“PDP”), a liquid crystal display and an organic light emitting display device, for example, but not being limited thereto. The display panel 300 includes a plurality of pixels arranged substantially in a matrix shape. In an exemplary embodiment, the display panel 300 displays one 2D image in a 2D mode. In such an embodiment, in the 3D mode, the display panel 300 may alternately display images corresponding to various image fields, e.g., right eye images and left eye images, by a space or time division method.

In an exemplary embodiment, referring to FIG. 1, the display panel 300 may alternately display a right eye image R and a left eye image L during a frame (e.g., an even-numbered frame) with a distance in a horizontal direction D1 with respect to an observer's position in the 3D mode. In an exemplary embodiment, the pixel that displayed the right eye image R in the frame may display the left eye image L and the pixel that displayed the left eye image L may display the right eye image R In a next frame (e.g., an odd-numbered frame), but the invention is not limited thereto. In an alternative exemplary embodiment, one pixel may continuously display one of the right eye and left eye images in consecutive frames. In an exemplary embodiment, the left eye image L and the right eye image R that are displayed during a unit frame may include substantial disparity information of a degree that is visible to a human eye.

The parallax barrier 400 may be turned on and off to divide the vision field of the image displayed in the display panel 300. The parallax barrier 400 is turned off when the display panel 300 is in the 2D mode, and the parallax barrier 400 is turned on when the display panel 300 is in the 3D mode such that the parallax barrier 400 performs a function of dividing the vision field of the image of the display panel 300.

The parallax barrier 400 includes a plurality of opening portions S and a plurality of block portions B, which are alternately arranged. The opening portions S transmit light from the display panel 300, and the block portions B block the light from the display panel 300. In an exemplary embodiment, the parallax barrier 400 may include a liquid crystal layer. In such an embodiment, the parallax barrier 400 independently controls the alignment of the liquid crystal molecules in each of a plurality of regions such that the opening portions S and the block portions B, which are alternately arranged, are provided thereon. A structure of the parallax barrier 400 including the liquid crystal layer will be described later in greater detail.

In an exemplary embodiment, the opening portions S and the block portions B of the parallax barrier 400 may be switched with each other every frame, as shown in FIG. 1, but not being limited thereto. In an alternative exemplary embodiment, the regions corresponding to the opening portions S in a frame may be the opening portions S in a next frame, and the regions corresponding to the block portions B in the frame may be the block portions B in the next frame. In an exemplary embodiment, where the positions of the opening portions S and the block portions B are switched every frame, the regions corresponding to the opening portions S in a frame may be changed into the block portions B in a next frame, and the regions corresponding to the block portions B in the frame may be changed into the opening portions S in the next frame.

In such an embodiment, the right eye of the observer may only recognize the right eye image R through the opening portion S of the parallax barrier 400 during a frame, and the left eye of the observer may only recognize the left eye image L such that the observer recognize the 3D image.

In an exemplary embodiment, as shown in FIG. 1, the right eye image R and the left eye image L displayed by the pixel of the display panel 300 are switched every frame, and simultaneously the opening portion S and the block portion B of the parallax barrier 400 are switched (also referred to as a “field sequential driving method”). In the field sequential driving method, the right eye or the left eye may recognize the images of all pixels through at least two consecutive frames such that a 3D image of the high resolution may be recognized.

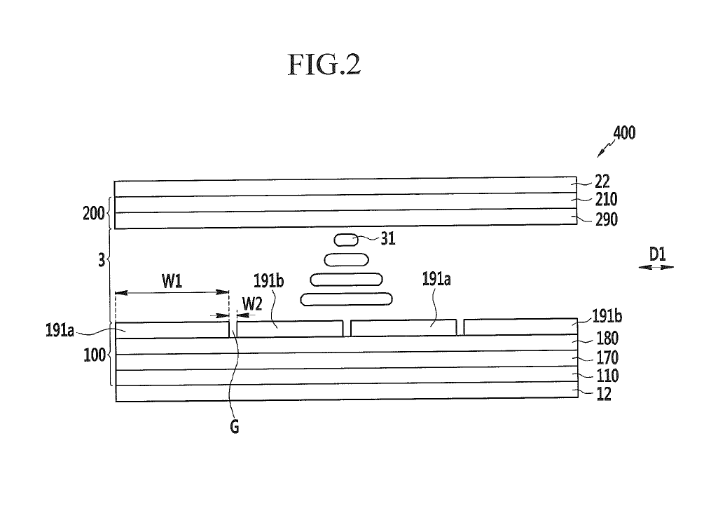

Hereinafter, an exemplary embodiment of the parallax barrier 400 according to the invention will be described with reference to FIGS. 2 to 5, in addition to FIG. 1.

FIG. 2 is a cross-sectional view of an exemplary embodiment of a parallax barrier according to the invention.

Referring to FIG. 2, the parallax barrier 400 includes two barrier panels, e.g., a lower barrier panel 100 and an upper barrier panel 200, which are opposite to, e.g., facing, each other, and a liquid crystal layer 3 interposed between the two barrier panels 100 and 200.

In an exemplary embodiment, the lower barrier panel 100 includes an insulation substrate 110 and a lower gap control electrode 170 disposed on the insulation substrate 110. The lower gap control electrode 170 may be a single plate on the insulation substrate 110, but not being limited thereto. The lower gap control electrode 170 may include a transparent conductive material such as indium tin oxide (“ITO”) or indium zinc oxide (“IZO”). In such an embodiment, a predetermined voltage may be applied to the lower gap control electrode 170, as shown in FIG. 1. In an exemplary embodiment, the parallax barrier may use a field sequential driving method such that the voltage applied to the lower gap electrode 170 may be changed at least every frame.

In an exemplary embodiment, the lower barrier panel 100 includes a first passivation layer 180 including an insulating material and disposed on the lower gap control electrode 170.

In an exemplary embodiment, the lower barrier panel 100 includes a liquid crystal control electrode including a plurality of unit liquid crystal control electrodes, and is disposed on the first passivation layer 180. In an exemplary embodiment, the unit liquid crystal control electrodes include a first liquid crystal control electrode 191a and a second liquid crystal control electrode 191b, which are alternately arranged.

In an exemplary embodiment, as shown in FIG. 2, the first liquid crystal control electrode 191a and the second liquid crystal control electrode 191b are alternately arranged in a horizontal direction D1, and a gap G of a predetermined distance is provided between two neighboring liquid crystal control electrodes, e.g., the first liquid crystal control electrode 191a and the second liquid crystal control electrode 191b. In an exemplary embodiment, a width W2 of the horizontal direction of the gap G is greater than 0 (zero) micrometer (μm) and less than 10 micrometers (μm), but not being limited thereto. In an exemplary embodiment, a width W1 of the first liquid crystal control electrode 191a or the second liquid crystal control electrode 191b in the horizontal direction D1 may be greater than 5 μm and less than 60 μm, but not being limited thereto. In an exemplary embodiment, the width W1 of the first liquid crystal control electrode 191a or the second liquid crystal control electrode 191b in the horizontal direction D1 may be determined based on a size of the pixel of the display panel 300 or eyesight of the left eye and the right eye that recognize the image through the parallax barrier 400. In one exemplary embodiment, for example, the width W1 of the first liquid crystal control electrode 191a or the second liquid crystal control electrode 191b in the horizontal direction D1 may correspond to the width of the horizontal direction of one pixel of the display panel 300. In such an embodiment, the first liquid crystal control electrode 191a or the second liquid crystal control electrode 191b corresponds to an opening portion S, and the left eye image L or the right eye image R displayed by the one pixel may be shown through the opening portion S.

In an exemplary embodiment, the liquid crystal control electrodes 191a and 191b may include a transparent conductive material, such as ITO or IZO, for example.

In an exemplary embodiment of the present invention, the lower gap control electrode 170 overlaps the gap G between the liquid crystal control electrodes 191a and 191b.

In an exemplary embodiment, as shown in FIG. 2, the upper barrier panel 200 includes an insulation substrate 210 and an opposing electrode 290 including a transparent conductive material, such as ITO or IZO, for example, and disposed on the insulation substrate 210. The opposing electrode 290 may be a single plate, but not being limited thereto. In an exemplary embodiment, the opposing electrode 290 may be disposed opposite to, e.g., facing, the liquid crystal control electrodes 191a and 191b of the lower barrier panel 100 such that an electric field may be generated in the liquid crystal layer 3.

In an exemplary embodiment, the liquid crystal layer 3 is disposed between the two barrier panels 100 and 200, and the liquid crystal layer 3 may include liquid crystal molecules 31 having anisotropy. The liquid crystal layer 3 may be a liquid crystal layer 3 of various modes, such as a twisted nematic (“TN”) or vertical alignment (“VA”) mode, for example. In an exemplary embodiment, an alignment layer (not shown) may be further provided at an inner surface of the barrier panels 100 and 200, and may have predetermined characteristics based on the mode of the liquid crystal layer 3.

In an exemplary embodiment, polarizers 12 and 22 are provided on an outer surface of the two barrier panels 100 and 200, respectively, and polarization axes of the two polarizers 12 and 22 may cross each other. In an alternative exemplary embodiment, the polarization axes of the two polarizers 12 and 22 may be substantially parallel to each other. In an exemplary embodiment, a parallax barrier may be a normally white mode barrier.

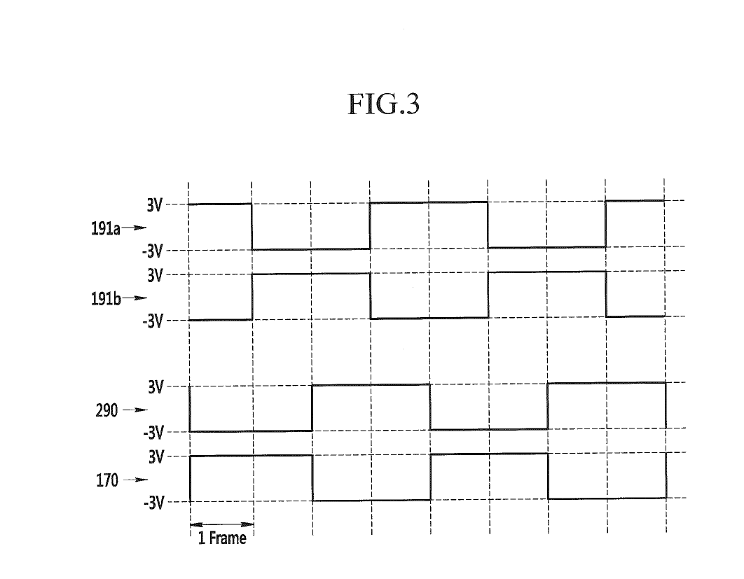

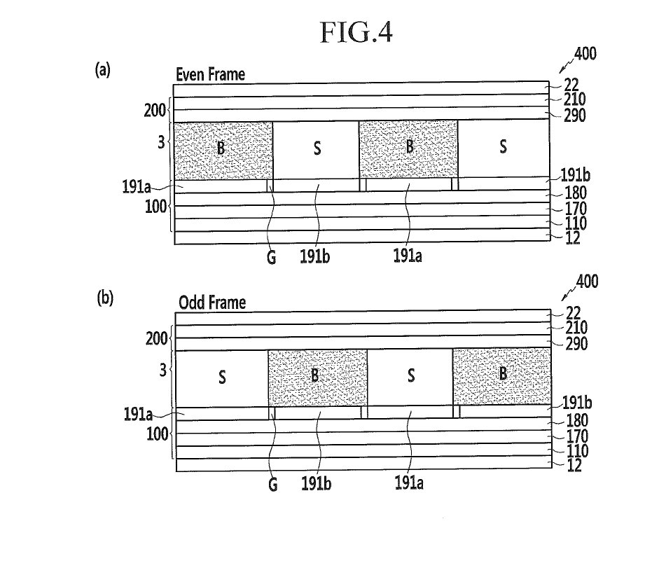

Hereinafter, an exemplary embodiment of a driving method of the parallax barrier shown in FIG. 2 will be described with reference to FIGS. 3 and 4.

FIG. 3 is a signal timing diagram showing driving voltages applied to the parallax barrier shown in FIG. 2, and FIGS. 4A and 4B are cross-sectional views of an exemplary embodiment of a parallax barrier, driven by the driving signals shown in FIG. 3. An exemplary embodiment of a driving method of the parallax barrier shown in FIG. 2 will be described for convenience of description, but the driving method of the parallax barrier shown in FIG. 2 is not limited to the exemplary embodiment shown in FIG. 3.

Referring to FIG. 3, when the first liquid crystal control electrode 191a is applied with a first voltage, e.g., 3 volts (V), the second liquid crystal control electrode 191b is applied with a second voltage, e.g., −3 V, different from the first voltage. In an exemplary embodiment, the opposing electrode 290, which is facing the first and second liquid crystal control electrodes 191a and 191b, may be applied with substantially the same voltage as the voltage of the first liquid crystal control electrode 191a and the voltage of the second liquid crystal control electrode 191b. In an exemplary embodiment, the opposing electrode 290 is applied with the second voltage, which is applied to the second liquid crystal control electrode 191b. In such an embodiment, the lower gap control electrode 170 may be applied with a different voltage from the voltage of the opposing electrode 290, for example, the first voltage.

The parallax barrier in different states based on the driving voltages will now be described with reference to FIGS. 4A and 4B.

Referring to FIGS. 4A and 4B, a portion of the liquid crystal layer 3 between the second liquid crystal control electrode 191b and the opposing electrode 290 that are applied with substantially the same voltage in a frame (e.g., even-numbered frame) defines the opening portion S, through which light is transmitted, along with the polarizers 12 and 22 such that the image of the display panel 300 may be transmitted to the parallax barrier 400. In such an embodiment, a portion of the liquid crystal layer 3 between the first liquid crystal control electrode 191a and the opposing electrode 290 that are applied with the different voltages defines the block portion B that blocks the light along with the polarizers 12 and 22 such that the image of the display panel 300 may not be transmitted to the parallax barrier 400. The block portion B and the opening portion S may be defined as the region where the light is not transmitted and the region where the light is transmitted in the parallax barrier 400 including the polarizers 12 and 22. Hereinafter, for convenience of description, the portions of the liquid crystal layer 3 corresponding to the block portion B and the opening portion S of the parallax barrier 400 will be referred to as the block portion B and the opening portion S of the liquid crystal layer 3, respectively.

Referring to FIG. 4B, the relationship of the voltage of the opposing electrode 290 and the voltage of the first and second liquid crystal control electrodes 191a and 191b is changed in a next frame. In an exemplary embodiment, when the voltage of the opposing electrode 290 is maintained as the second voltage, the voltage of the first liquid crystal control electrode 191 a may be changed into the second voltage and the voltage of the second liquid crystal control electrode 191b may be changed into the first voltage. In such an embodiment, as shown in FIG. 4B, the opening portion S and the block portion B of the liquid crystal layer 3 of the frame are switched into the block portion B and the opening portion S, respectively, in the next frame.

In an exemplary embodiment, the voltage of the first and second liquid crystal control electrodes 191a and 191b in the next frame is maintained substantially the same as the voltage of the first and second liquid crystal control electrodes 191a and 191b in the frame, and the voltage of the opposing electrode 290 may be changed into a different voltage from the voltage of the opposing electrode 290 in the frame. In an exemplary embodiment, the voltage of the first and second liquid crystal control electrodes 191a and 191b may be maintained and the voltage of the opposing electrode 290 may be changed when a second frame is changed into a third frame as shown in FIG. 3.

In an exemplary embodiment of the invention, the liquid crystal molecules 31 of the liquid crystal layer 3 corresponding to the gap G between the first and second liquid crystal control electrodes 191a and 191b may be controlled by the opposing electrode 290 and the lower gap control electrode 170. In an exemplary embodiment, as shown in FIG. 3, the voltage of the lower gap control electrode 170 is different from the voltage of the opposing electrode 290 such that the electric field is applied to the liquid crystal layer 3 between the opposing electrode 290 and the lower gap control electrode 170, and the liquid crystal layer 3 corresponding to the gap G between the first and the second liquid crystal control electrodes 191a and 191b becomes the block portion B. In such an embodiment, as shown in FIG. 4, the widths of the first liquid crystal control electrode 191 a and the second liquid crystal control electrode 191b in the horizontal direction are substantially the same as each other, and the width of the block portion B of a frame in the horizontal direction is greater than the width of the opening portion S of the frame in the horizontal direction.

As described above, in an exemplary embodiment of the invention, the light transmitting to the liquid crystal layer 3 corresponding to the gap G between the first and second liquid crystal control electrodes 191a and 191b is not passing therethrough, that is, the light transmitting to the liquid crystal layer 3 corresponding to the gap G between the first and second liquid crystal control electrodes 191a and 191b is not passing through the parallax barrier 400, such that front crosstalk between the left eye image and the right eye image, which may occur when the parallax barrier 400 does not completely block the left eye image input to the right eye or does not completely block the right eye image input to the left eye, is effectively prevented.

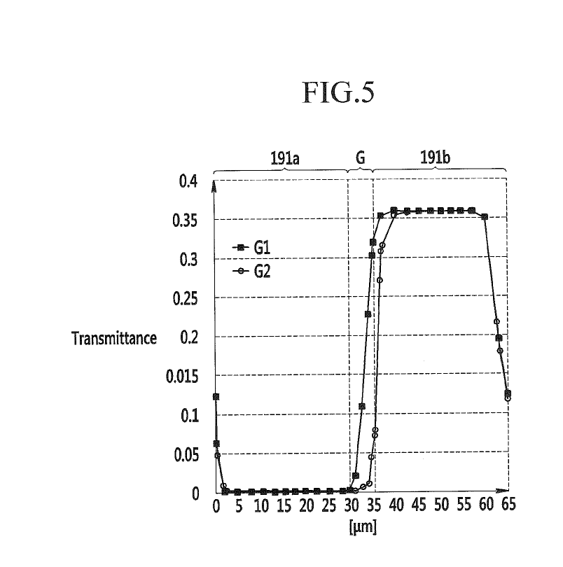

FIG. 5 is a graph showing transmittance of the parallax barrier shown in FIG. 2,

In FIG. 5, a curve G1 shows transmittance according to position on a parallax barrier measured in pm in the horizontal direction D1 based on the light passing through the parallax barrier, where the parallax barrier does not include the lower gap control electrode 170, and a curve G2 shows transmittance according to position on a parallax barrier in the horizontal direction D1 based on the light passing through the parallax barrier, where the parallax barrier includes the lower gap control electrode 170 according to an exemplary embodiment of the invention.

As shown by the curves G1 and G2, the transmittance of a portion of the parallax barrier corresponding to the first liquid crystal control electrode 191a and the opposing electrode 290, which are applied with the different voltages, is about zero (0), and the transmittance of a portion of the parallax barrier corresponding to the second liquid crystal control electrode 191b and the opposing electrode 290, which are applied with substantially the same voltages, is substantially high. As shown by the curve G1, the transmittance of the parallax barrier corresponding to the gap G between the first and second liquid crystal control electrodes 191a and 191b is substantially high, while as shown by the curve G2, the transmittance of an exemplary embodiment of the parallax barrier corresponding to the gap G between the first and second liquid crystal control electrodes 191a and 191b is substantially low, e.g., about zero (0).

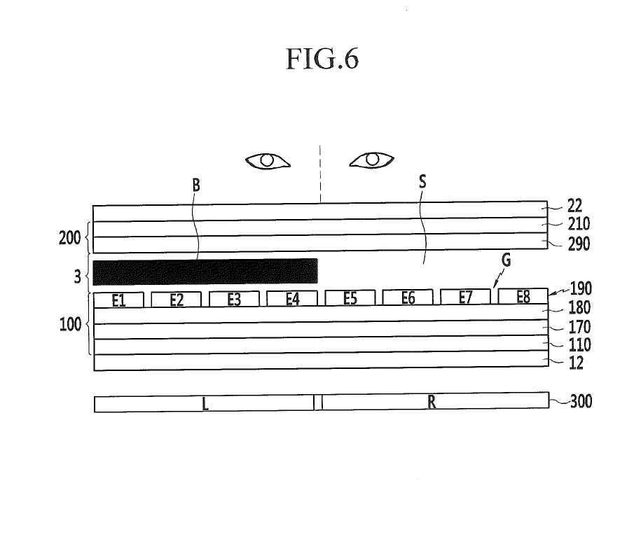

Next, an exemplary embodiment of the parallax barrier will be described with reference to FIGS. 6 to 12.

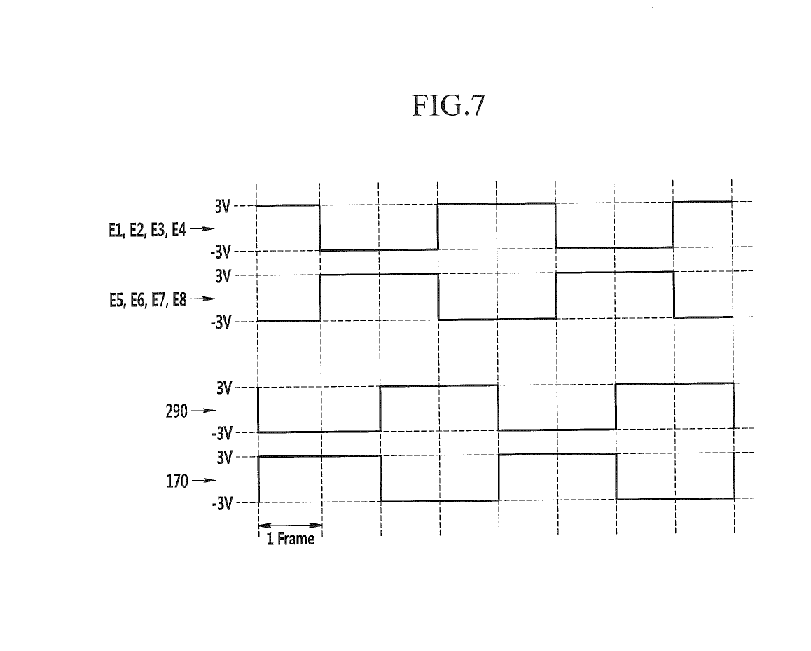

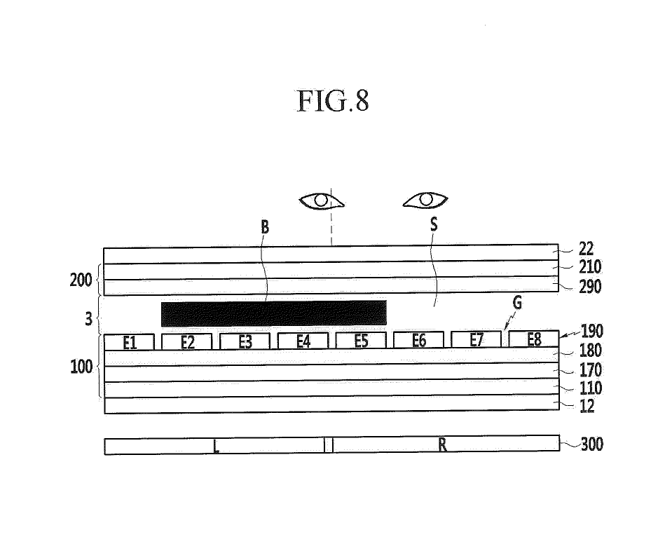

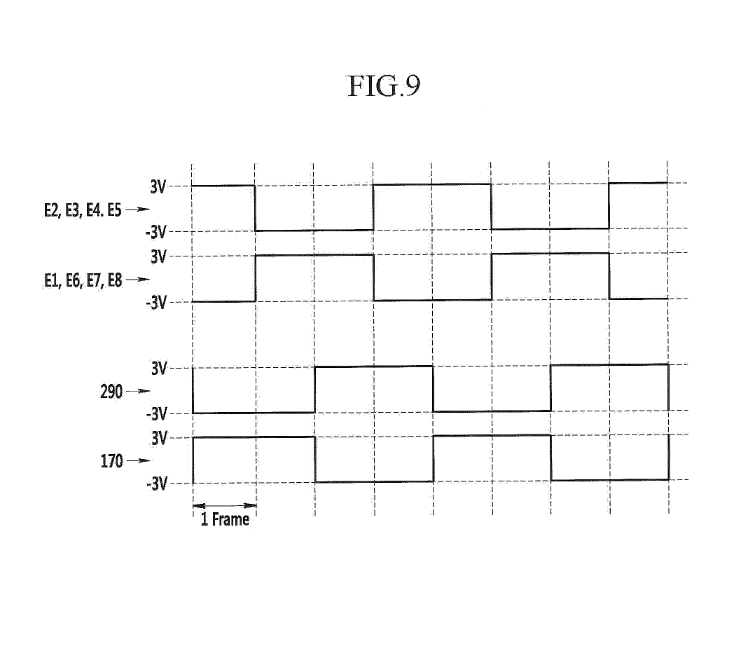

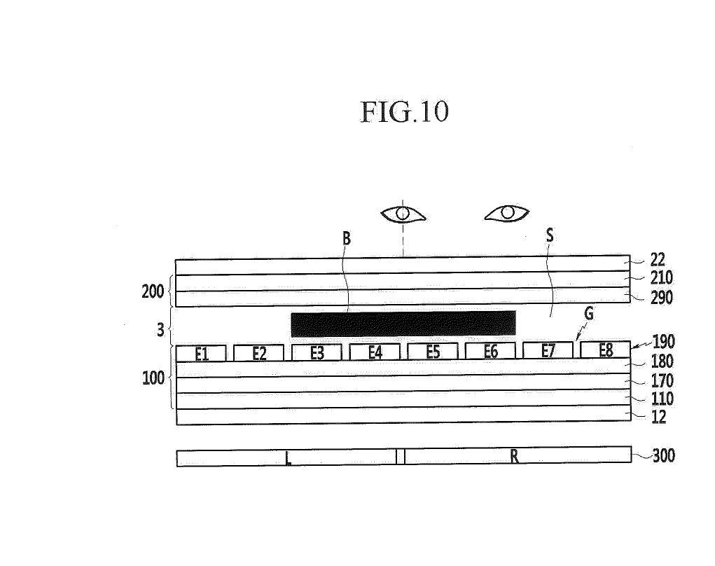

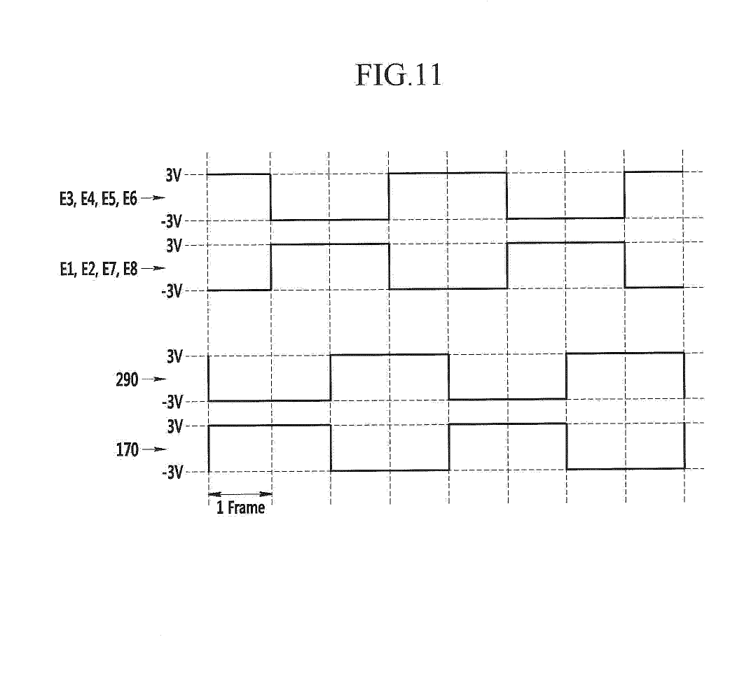

FIG. 6 is a cross-sectional view of an exemplary embodiment of a parallax barrier according to the invention, FIG. 7 is a signal timing diagram showing driving voltages applied to the parallax barrier shown in FIG. 6, FIG. 8 is a cross-sectional view of the parallax barrier shown in FIG. 6 in a different state, FIG. 9 is one example of a waveform of several driving voltages of the parallax barrier shown in FIG. 8, FIG. 10 is a cross-sectional view of the parallax barrier of FIG. 6 in another different state, and FIG. 11 is a signal timing diagram showing driving voltages applied to the parallax barrier shown in FIG. 10.

The parallax barrier and a driving method thereof shown in FIGS. 6 to 11 are substantially the same as the parallax barrier and the driving method thereof shown in FIGS. 2 to 5, and any repetitive detailed description thereof will hereinafter be omitted or simplified.

Referring to FIGS. 6, 8 and 10, in an exemplary embodiment of the parallax barrier, the liquid crystal control electrode 190 is disposed on the first passivation layer 180. The liquid crystal control electrode 190 includes a plurality of unit liquid crystal control electrodes, e.g., first to eighth unit liquid crystal control electrodes E1 to E8, spaced apart from each other with a gap G therebetween. In an exemplary embodiment, as shown in FIGS. 6, 8 and 10, the liquid crystal control electrode 190 may include eight unit liquid crystal control electrodes E1 to E8, but the number of unit liquid crystal control electrodes is not limited thereto.

In an exemplary embodiment, the lower gap control electrode 170 disposed under the liquid crystal control electrode 190 overlaps the gap G between the plurality of unit liquid crystal control electrodes E1 to E8, and may generate the electric field to the liquid crystal layer 3 along the opposing electrode 290 of the upper barrier panel 200.

Referring to FIGS. 6 and 7, the driving signals applied to the exemplary embodiment shown in FIG. 6 are substantially the same as the driving signals shown in FIG. 3. In an exemplary embodiment, at least two neighboring unit liquid crystal control electrodes E1 to E8 are applied with substantially the same voltage, thereby defining one opening portion S or one block portion B of the liquid crystal layer 3. In such an embodiment, the neighboring unit liquid crystal control electrodes E1 to E8 of the predetermined number may correspond to one first liquid crystal control electrode 191a or one second liquid crystal control electrode 191b

In one exemplary embodiment, for example, four neighboring unit liquid crystal control electrodes, e.g., first to fourth unit liquid crystal control electrodes E1, E2, E3 and E4 or the fifth to eighth unit liquid crystal control electrodes E5, E6, E7 and E8, may correspond to an opening portion S or a block portion B. Referring to FIG. 7, the first to fourth unit liquid crystal control electrodes E1, E2, E3 and E4 and the lower gap control electrode 170 may be applied with the first voltage (e.g., 3 V) in a frame, and the fifth to eighth unit liquid crystal control electrodes E5, E6, E7 and E8 and the opposing electrode 290 may be applied with the second voltage (e.g., −3 V) different from the first voltage in the frame such that a portion of the liquid crystal layer 3 corresponding to the first to fourth unit liquid crystal control electrodes E1, E2, E3 and E4 defines a block portion B, and a portion of the liquid crystal layer 3 corresponding to the fifth to eighth unit liquid crystal control electrodes E5, E6, E7 and E8 defines an opening portion S.

In an exemplary embodiment, the lower gap control electrode 170 corresponding to the gap G generates the electric field to the liquid crystal layer 3 along with the opposing electrode 290 such that a portion of the liquid crystal layer 3 corresponding to the gap G becomes the block portion B. In such an embodiment, a transmission region does not exist in the block portion B corresponding to the unit liquid crystal control electrodes E1, E2, E3, and E4 such that the corresponding image to be blocked is substantially completely blocked and the front crosstalk is thereby effectively prevented.

Referring to FIGS. 8 and 9, when the position of the observer is changed, the position of the block portion B of the parallax barrier may be changed based on the position of the observer. In one exemplary embodiment, for example, as shown in FIG. 8, when the eye of the observer is moved to the right side, the block portion B and the opening portion S are moved to the right side such that the left eye image is input to the left eye and the right eye image is input to the right.

Referring to FIG. 9, in an exemplary embodiment, the second to fifth unit liquid crystal control electrodes E2, E3, E4 and E5 and the lower gap control electrode 170 are applied with the first voltage (e.g., 3 V), and the first and sixth to eighth unit liquid crystal control electrodes E1, E6, E7 and E8 and the opposing electrode 290 are applied with the second voltage (e.g., −3 V) different from the first voltage such that a portion of the liquid crystal layer 3 corresponding to the second to fifth unit liquid crystal control electrodes E2, E3, E4 and E5 defines a block portion B, and the liquid crystal layer 3 corresponding to the first and sixth to eighth unit liquid crystal control electrodes E1, E6, E7 and E8 defines an opening portion S.

Likewise, as shown in FIGS. 10 and 11, when the observer is further moved to the right side, the position of the block portion B may be further moved to the right side. In one exemplary embodiment, for example, the third to sixth unit liquid crystal control electrodes E3, E4, E5 and E6 and the lower gap control electrode 170 may be applied with the first voltage (e.g., 3 V), and the first, second, seventh and eighth unit liquid crystal control electrodes E1, E2, E7 and E8 and the opposing electrode 290 may be applied with the second voltage (e.g., −3 V) different from the first voltage such that a portion of the liquid crystal layer 3 corresponding to the third to sixth unit liquid crystal control electrodes E3, E4, E5, and E6 defines a block portion B, and the liquid crystal layer 3 corresponding to the first, second, seventh and eighth unit liquid crystal control electrodes E1, E2, E7 and E8 defines an opening portion S.

In an exemplary embodiment, a sensor such as a charge-coupled device (“CCD”) camera to sense the position of the observer may be provided for the parallax barrier. To sense the position of the observer through the sensor, as shown in FIGS. 6 to 10, the position of the block portion B or the opening portion S may be shifted based on the position of the observer. In such an embodiment, the width of the horizontal direction of the unit liquid crystal control electrodes E1 to E8 less than the width of the horizontal direction of the first or second liquid crystal control electrodes 191a and 191b, as shown in FIG. 2 to FIG. 5. In one exemplary embodiment, for example, as shown in FIGS. 6, 8 and 10, the entire width of the horizontal direction of at least two neighboring unit liquid crystal control electrodes E1 to E8 defining a block portion B or an opening portion S may correspond to the width of the horizontal direction of one pixel that displays the left eye image L or the right eye image R in the display panel 300.

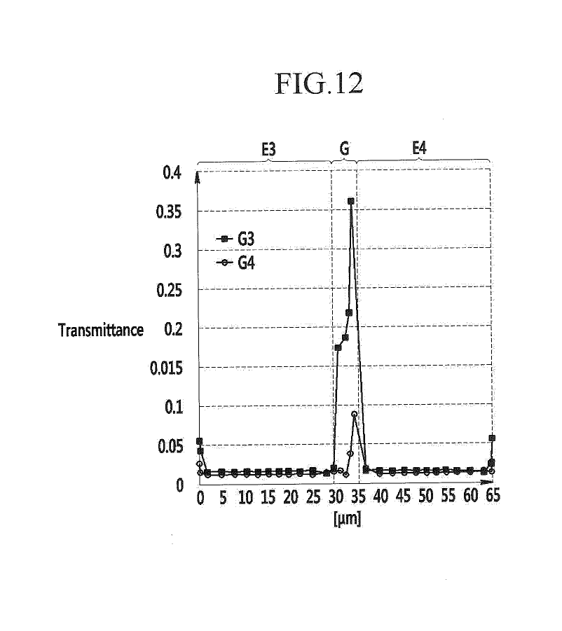

FIG. 12 is a graph showing transmittance of the parallax barrier shown in FIGS. 6, 8 and 10,

In FIG. 12, a curve G3 shows transmittance according to position on a parallax barrier in a horizontal direction D1 based on light passing through the parallax barrier that does not include the lower gap control electrode 170, and a curve G4 shows transmittance according to position of a horizontal direction D1 on an exemplary embodiment of a parallax barrier in the horizontal direction D1 based on light passing through the parallax barrier.

The two curves G3 and G4 in FIG. 12 may have substantially the same characteristics as the curves G1 and G2 shown in FIG. 5. In the curve G3, the transmittance passing through the gap G between the third and fourth unit liquid crystal control electrodes E3 and E4 is substantially high, while in the curve G4 of an exemplary embodiment of a parallax barrier, the transmittance of a portion of the parallax barrier corresponding to the gap G between the unit liquid crystal control electrodes E3 and E4 is substantially low, e.g., about zero (0).

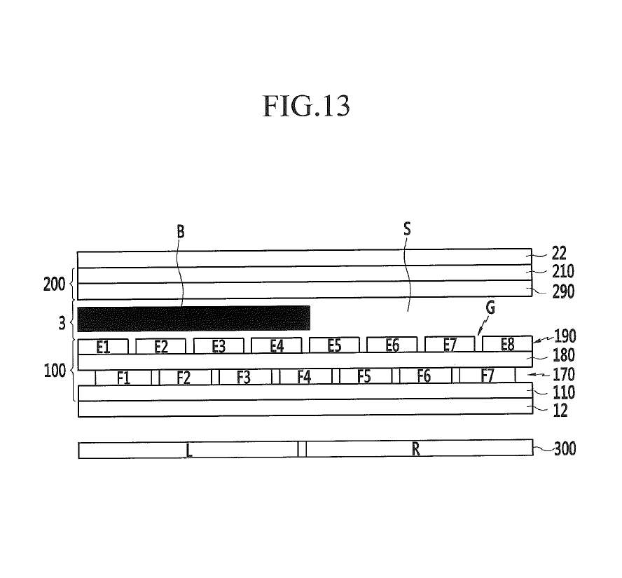

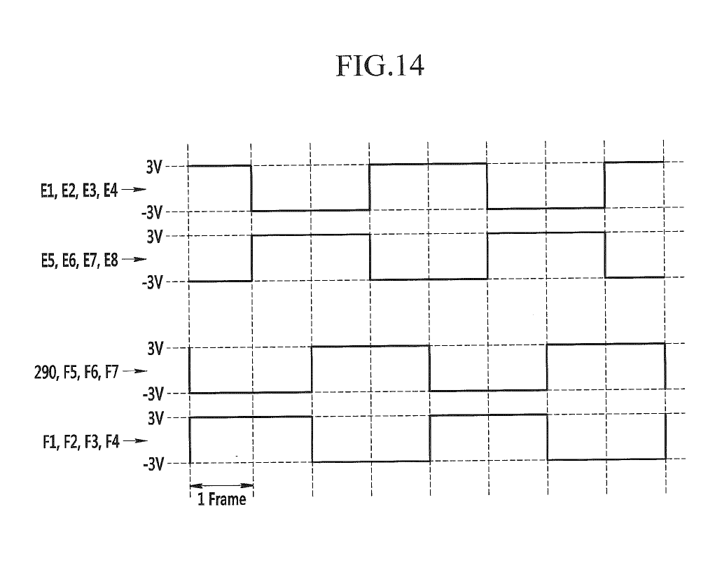

Hereinafter, referring to FIGS. 13 and 14, an alternative exemplary embodiment of a parallax barrier according to the invention will be described.

FIG. 13 is a cross-sectional view of an alternative exemplary embodiment of a parallax barrier according to the invention, and FIG. 14 is a signal timing diagram showing driving voltages applied to the parallax barrier shown in FIG. 13.

The parallax barrier and a driving method thereof shown in FIGS. 13 and 14 are substantially the same as the parallax barrier shown in FIG. 6 to FIG. 12, and any repetitive detailed description thereof will hereinafter be omitted or simplified.

Referring to FIG. 13, the exemplary embodiment of the parallax barrier is substantially the same as the parallax barrier shown in FIG. 6, except that the lower gap control electrode 170 of the lower barrier panel 100 is not a single plate but includes a plurality of unit gap control electrodes, e.g., first to seventh unit gap control electrode F1 to F7, spaced apart from each other with a gap. In an exemplary embodiment, the number of unit gap control electrodes may be seven as shown in FIG. 13, but not being limited thereto.

The unit gap control electrodes F1 to F7 are disposed overlapping the gap G between the plurality of unit liquid crystal control electrodes, e.g., the first to eighth unit liquid crystal control electrodes E1 to E8, and facing the opposing electrode 290 of the upper barrier panel 200 via the liquid crystal layer 3.

In an exemplary embodiment, as shown in FIG. 14, the first to fourth unit liquid crystal control electrodes E1, E2, E3 and E4, and the first to fourth unit gap control electrodes F1, F2, F3 and F4 may be applied with the first voltage (e.g., 3 V) in a frame, and the fifth to eighth unit liquid crystal control electrodes E5, E6, E7 and E8, the fifth to seventh unit gap control electrodes F5, F6 and F7, and the opposing electrode 290 may be applied with the second voltage (e.g., −3 V) different from the first voltage. In such an embodiment, the liquid crystal layer 3 corresponding to the first to fourth unit liquid crystal control electrodes E1, E2, E3 and E4 defines a block portion B, and the liquid crystal layer 3 corresponding to the fifth to eighth unit liquid crystal control electrodes E5, E6, E7 and E8 defines an opening portion S.

In an exemplary embodiment, the first to fourth unit gap control electrodes F1, F2, F3 and F4 corresponding to the gap G between the first to fourth unit liquid crystal control electrodes E1, E2, E3 and E4 defining the block portion B generate the electric field to the liquid crystal layer 3 along with the opposing electrode 290 such that light transmittance is effectively prevented in the portion corresponding to the first to fourth unit liquid crystal control electrodes E1, E2, E3 and E4. In such an embodiment, the block portion B defined by the first to fourth unit liquid crystal control electrodes E1, E2, E3 and E4 substantially completely blocks the corresponding image such that the front crosstalk is effectively prevented.

In an exemplary embodiment, the fifth to seventh unit gap control electrodes F5, F6 and F7, which face the gaps G between the fifth to eighth unit liquid crystal control electrodes E5, E6, E7 and E8 forming an opening portion S, are supplied with a same voltage as the voltage applied to the opposing electrode 290, and the fifth to seventh unit gap control electrodes F5, F6 and F7 and the opposing electrode 290 do not generate an electric field in the liquid crystal layer 3. In such an embodiment, the fifth to seventh unit gap control electrodes F5, F6 and F7 and the opposing electrode 290 do not form a block portion B in the liquid crystal layer 3 such that a light blocking portion, through which light is blocked from being transmitted, is not formed in the middle of the opening portion S formed by the fifth to eighth unit liquid crystal control electrodes E5, E6, E7 and E8. In such an embodiment, no light is transmitted through substantially an entire portion of the opening portion S such that light corresponding to an image is substantially completely transmitted through the liquid crystal layer 3 in the opening portion S such that luminance of the image increases.

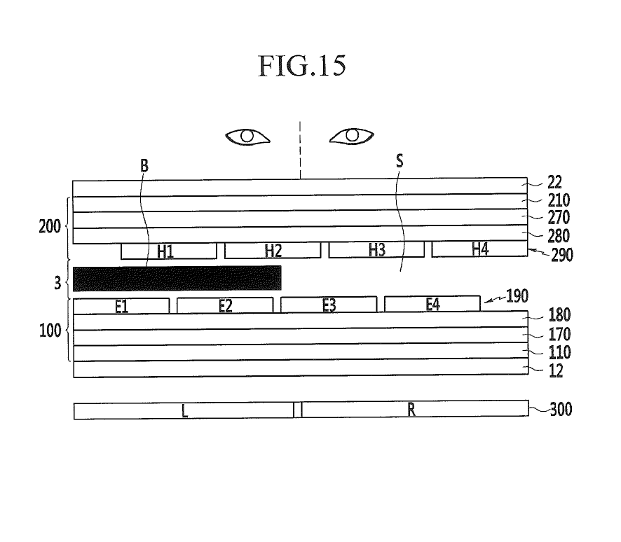

Hereinafter, another alternative exemplary embodiment of a parallax barrier according to the invention will be described referring to FIGS. 15 to 19.

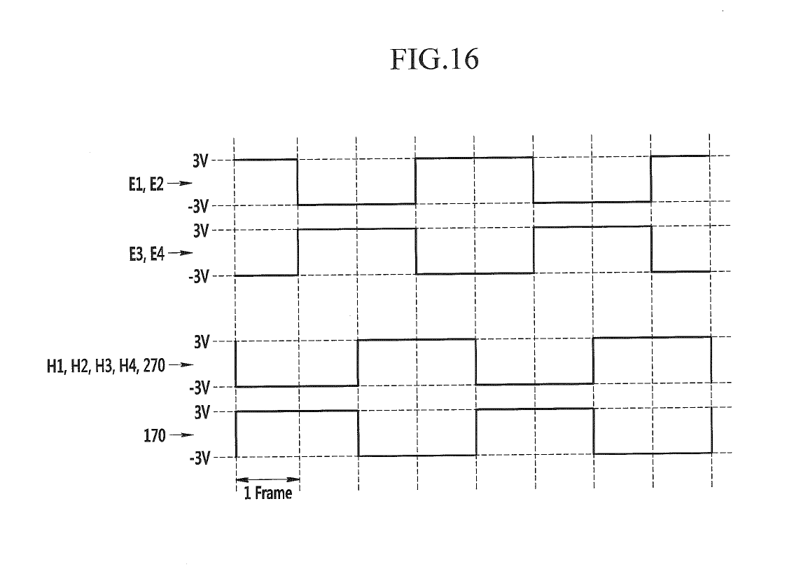

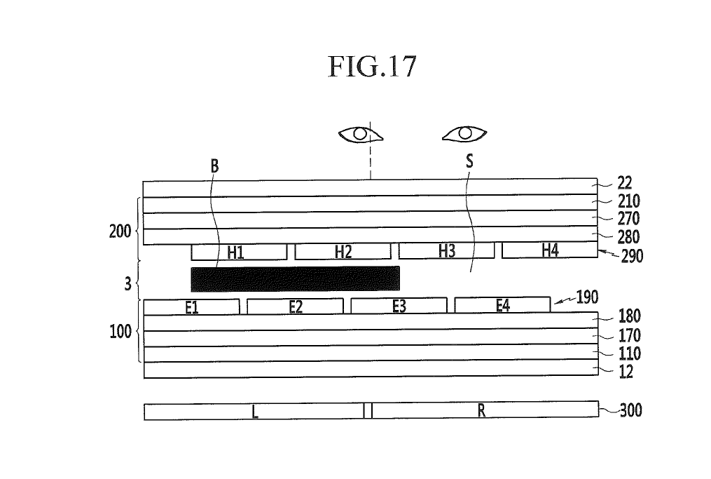

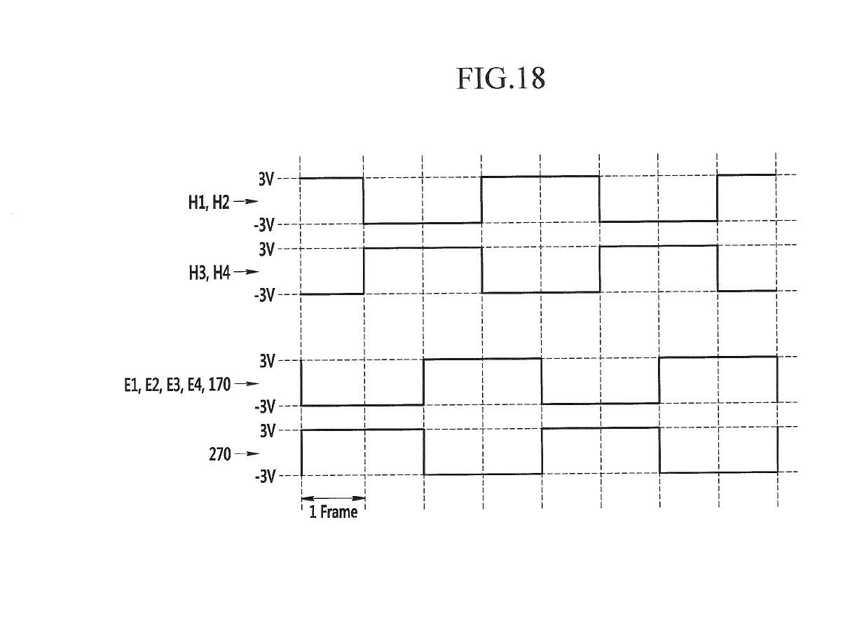

FIG. 15 is a cross-sectional view of another alternative exemplary embodiment of a parallax barrier according to the invention, FIG. 16 is a signal timing diagram showing driving voltages applied to the parallax barrier shown in FIG. 15, FIG. 17 is a cross-sectional view of the parallax barrier of FIG. 15 in a different state, and FIG. 18 is a signal timing diagram showing driving voltages applied to the parallax barrier shown in FIG. 17.

Referring to FIGS. 15 and 17, the lower gap control electrode 170 is disposed on the insulation substrate 110 of the lower barrier panel 100, the first passivation layer 180 is disposed on the lower gap control electrode 170, and the liquid crystal control electrode 190 including a plurality of unit liquid crystal control electrodes, e.g., first to fourth unit liquid crystal control electrode E1, E2, E3 and E4, is disposed on the first passivation layer 180. The lower gap control electrode 170 overlaps the gap between the plurality of unit liquid crystal control electrodes E1, E2, E3 and E4.

The upper gap control electrode 270 is disposed on the insulation substrate 210 of the upper barrier panel 200. The upper gap control electrode 270 may be a single plate, similarly to the lower gap control electrode 170, but not being limited thereto. The upper gap control electrode 270 may include a transparent conductive material such as ITO or IZO, for example. In an exemplary embodiment, the upper gap control electrode 270 may be applied with a predetermined constant voltage. In an alternative exemplary embodiment, the upper gap control electrode 270 may be applied with a voltage that is changed at least every frame based on the field sequential driving method, as shown in FIG. 1.

The second passivation layer 280 including an insulating material is disposed on the upper gap control electrode 270.

The opposing electrode 290 including a plurality of unit opposing electrodes, e.g., first to fourth unit opposing electrodes H1, H2, H3 and H4, is disposed on the second passivation layer 280. The upper gap control electrode 270 overlaps the gap between the unit opposing electrodes H1, H2, H3 and H4, and may generate an electric field in the liquid crystal layer 3 along with the third and fourth unit liquid crystal control electrodes E3 and E4 of the lower barrier panel 100. Also, the lower gap control electrode 170 of the lower barrier panel 100 may generate an electric field in the liquid crystal layer 3 along with the first and second unit opposing electrodes H1 and H2 of the upper barrier panel 200 through the gap between the first to fourth unit liquid crystal control electrodes E1, E2, E3 and E4.

In an exemplary embodiment, the first to fourth unit opposing electrodes H1, H2, H3 and H4 of the upper barrier panel 200 may not be edge-to-edge aligned with the unit liquid crystal control electrodes E1, E2, E3 and E4 of the lower barrier panel 100. In an exemplary embodiment, one of the unit opposing electrodes H1, H2, H3 and H4 may simultaneously overlap two neighboring unit liquid crystal control electrodes E1, E2, E3 and E4. The width of the overlapping portion of the unit opposing electrodes H1, H2, H3 and H4 and the unit liquid crystal control electrodes E1, E2, E3 and E4 facing each other may be about half of an entire width of the unit opposing electrodes H1, H2, H3 and H4 or may be about half of an entire width of the unit liquid crystal control electrodes E1, E2, E3 and E4. The unit opposing electrodes H1, H2, H3 and H4 and the unit liquid crystal control electrodes E1, E2, E3 and E4, as in FIGS. 15 and 17, are applied with the voltage substantially similar to the voltage applied to the exemplary embodiment shown in FIG. 6, and may have a similar function as the exemplary embodiment shown in FIG. 6.

In such an embodiment, one of the unit liquid crystal control electrodes, e.g., the second unit liquid crystal control electrode E2, overlaps two unit opposing electrodes, e.g., the first and second unit opposing electrodes H1 and H2, such that the liquid crystal layer 3 between the one of the unit liquid crystal control electrodes E2 and the two unit opposing electrodes H1 and H2 may be one of the block portion B and the opening portion S based on the voltage difference therebetween. In such an embodiment, the liquid crystal control electrode 190 of the lower barrier panel 100 is divided into a plurality of unit electrodes spaced apart from each other, the opposing electrode 290 of the upper barrier panel 200 is divided into a plurality of unit electrodes spaced apart from each other, and the unit electrodes of the liquid crystal control electrode 190 and the unit electrodes of the opposing electrode 290 are not edge-to-edge aligned with each other, such that the number of unit electrodes disposed at one of the two barrier panels 100 or 200 may be reduced by half. In such an embodiment, the liquid crystal layer 3 may be divided into increased number of portions to form the opening portion S and the block portion B without reducing the width of the unit electrodes. In such an embodiment, the pattern formation of the unit electrode may be substantially efficient.

Referring to FIG. 16, in a frame, the first and second unit liquid crystal control electrodes E1 and E2 and the lower gap control electrode 170 are applied with the first voltage (e.g., 3 V), and the third and fourth unit liquid crystal control electrodes E3 and E4, the first to fourth unit opposing electrodes H1, H2, H3 and H4, and the upper gap control electrode 270 are applied with the second voltage (e.g., −3 V) different from the first voltage such that, as shown in FIG. 15, the liquid crystal layer 3 corresponding to the first and second unit liquid crystal control electrodes E1 and E2 forms a block portion B, and the liquid crystal layer 3 corresponding to the third and fourth unit liquid crystal control electrode E3 and E4 defines an opening portion S.

In such an embodiment, the lower gap control electrode 170 corresponding to the gap between the first and second unit liquid crystal control electrodes E1 and E2 defining the block portion B generate an electric field in the liquid crystal layer 3 along with the first and second unit opposing electrodes H1 and H2 such that a transparent portion, through which the light is transmitted, may not be generated in the block portion B corresponding to the first and second unit liquid crystal control electrodes E1 and E2. Accordingly, the block portion B corresponding to the first and second unit liquid crystal control electrodes E1 and E2 substantially completely blocks the light corresponding to an image such that the front crosstalk is effectively prevented.

In an exemplary embodiment, the third and fourth unit liquid crystal control electrodes E3 and E4 and the third and fourth unit opposing electrodes H3 and H4 are applied with substantially the same voltage, thereby forming the opening portion S at the corresponding portion in the liquid crystal layer 3. The upper gap control electrode 270 and the third and fourth unit liquid crystal control electrodes E3 and E4 corresponding to the gap between the third and fourth unit opposing electrodes H3 and H4 are applied with substantially the same voltage such that the light may be completely transmitted. In such an embodiment, when the upper gap control electrode 270 and the third and fourth unit liquid crystal control electrodes E3 and E4 corresponding to the gap between the third and fourth unit opposing electrodes H3 and H4 are applied with a different voltage, a light blocking portion may be formed at the liquid crystal layer 3.

Referring to FIGS. 17 and 18, when the position of the observer is changed, the position of the block portion B of the parallax barrier shown in FIG. 15 may be changed based on the changed position of the observer. In one exemplary embodiment, for example, as shown in FIG. 17, when the eye of the observer is moved to the right side, the block portion B and the opening portion S are together moved to the right side such that the left eye image may be input to the left eye and the right eye image may be input to the right eye.

Referring to FIG. 18, the first and second unit opposing electrodes H1 and H2 and the upper gap control electrode 270 may be applied with the first voltage (e.g., 3 V), and the third and fourth unit opposing electrodes H3 and H4, the first to fourth unit liquid crystal control electrodes E1, E2, E3 and E4, and the lower gap control electrode 170 may be applied with the second voltage (e.g., −3 V) different from the first voltage. Thus, the liquid crystal layer 3 corresponding to the first and second unit opposing electrodes H1 and H2 forms a block portion B, and the liquid crystal layer 3 corresponding to the third and fourth unit opposing electrodes H3 and H4 forms one opening portion S. Accordingly, the block portion B of FIG. 15 may be moved to the right side by about half of the width the width of one of the unit opposing electrodes H1, H2, H3 and H4 or one of the unit liquid crystal control electrodes E1, E2, E3 and E4 in the horizontal direction.

In an exemplary embodiment, a sensor such as a CCD camera to sense the position of the observer may be included in the parallax barrier. The characteristics of the parallax barrier shown in FIGS. 15 to 18 may be substantially the same as the characteristics of the exemplary embodiment shown in FIGS. 6 to 12.

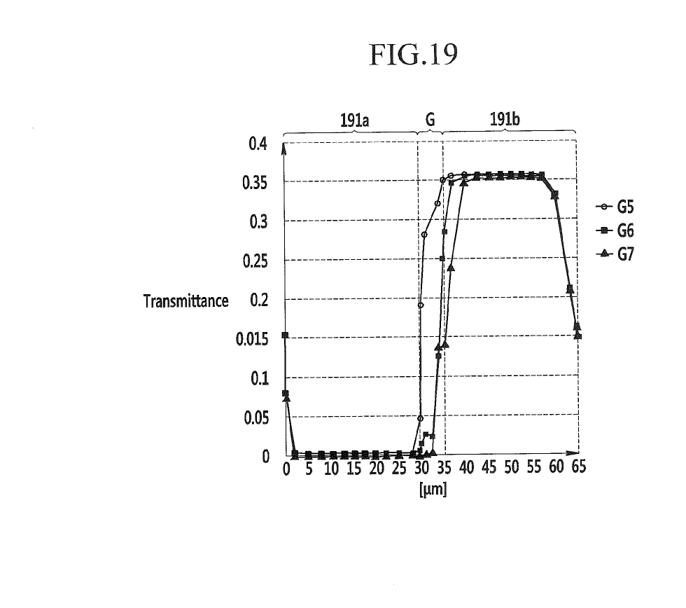

FIG. 19 is a graph showing transmittance of the parallax barrier according to voltage applied to the lower gap control electrode 170 in the parallax barrier shown in FIG. 2. In FIG. 19, a curve G5 shows transmittance when a voltage difference between the lower gap control electrode 170 and the opposing electrode 290 of the upper barrier panel 200 is about zero (0), a curve G6 shows transmittance when a voltage difference between the lower gap control electrode 170 and the opposing electrode 290 of the upper barrier panel 200 is about 3 V, and a curve G7 shows transmittance when a voltage difference between the lower gap control electrode 170 and the opposing electrode 290 of the upper barrier panel 200 is about 6 V.

As shown by the curves G5, G6 and G7, as the voltage difference between the lower gap control electrode 170 of the lower barrier panel 100 and the opposing electrode 290 of the upper barrier panel 200 increase, the transmittance of the liquid crystal layer 3 corresponding to the gap G between the first and second liquid crystal control electrodes 191a and 191 may decrease. In an exemplary embodiment, the voltage difference between the electrode of the upper barrier panel 200 and the electrode of the lower barrier panel 100 facing each other through the gap between the (unit) liquid crystal control electrodes or the unit opposing electrodes is substantially great such that the left eye image or the right eye image to be blocked may be substantially completely blocked by the block portion B in the liquid crystal layer 3 corresponding to the gap between the (unit) liquid crystal control electrodes or the unit opposing electrodes, and the front crosstalk is thereby effectively prevented.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A parallax barrier for a three-dimensional (3D) image display, comprising:
a first substrate;
a second substrate opposite to the first substrate;
a first gap control electrode disposed on the first substrate;
a first passivation layer disposed on the first gap control electrode;
a liquid crystal control electrode disposed on the first passivation layer;
an opposing electrode disposed on the second substrate; and
a liquid crystal layer interposed between the first substrate and the second substrate,
wherein the liquid crystal control electrode includes a plurality of unit liquid crystal control electrodes,
wherein two neighboring unit liquid crystal control electrodes are spaced apart with a gap, and
wherein the first gap control electrode overlaps the gap between the unit liquid crystal control electrodes.

2. The parallax barrier for the 3D image display of claim 1, wherein
at least a portion of the first gap control electrode and at least a portion of the opposing electrode are applied with different voltages such that a block portion is formed in the liquid crystal layer corresponding to the gap between the unit liquid crystal control electrodes.

3. The parallax barrier for the 3D image display of claim 2, wherein
the first gap control electrode includes a plurality of unit gap control electrodes,
two neighboring unit gap control electrodes are spaced apart from each other, and
each of the unit gap control electrodes overlaps the gap between two corresponding unit liquid crystal control electrodes.

4. The parallax barrier for the 3D image display of claim 3, wherein
a voltage applied to a portion of the unit gap control electrodes is substantially the same as a voltage applied to the opposing electrode.

5. The parallax barrier for the 3D image display of claim 4, wherein
the opposing electrode includes a plurality of unit opposing electrodes,
two neighboring unit opposing electrodes are spaced apart from each other with a gap, and
each of the unit opposing electrodes overlaps both of two corresponding unit liquid crystal control electrodes.

6. The parallax barrier for the 3D image display of claim 5, further comprising:
a second gap control electrode disposed between the second substrate and the opposing electrode.

7. The parallax barrier for the 3D image display of claim 6, wherein
at least a portion of second gap control electrode and at least a portion of the unit liquid crystal control electrodes are applied with different voltages such that the block portion is formed in the liquid crystal layer corresponding to the gap between the unit opposing electrodes.

8. The parallax barrier for the 3D image display of claim 2, wherein
two neighboring unit liquid crystal control electrodes are applied with different voltages such that the liquid crystal layer corresponding to one of the two neighboring unit liquid crystal control electrodes forms the block portion or an opening portion.

9. The parallax barrier for the 3D image display of claim 2, wherein
at least two neighboring unit liquid crystal control electrodes are applied with a same voltage such that the liquid crystal layer corresponding to the at least two neighboring unit liquid crystal control electrodes forms the block portion or an opening portion.

10. The parallax barrier for the 3D image display of claim 9, further comprising:
a sensing unit which senses a position of an observer,
wherein a position of the block portion or a position of the opening portion corresponding to the unit liquid crystal control electrodes is changed based on the position of the observer sensed by the sensing unit.

11. The parallax barrier for the 3D image display of claim 10, wherein
the first gap control electrode includes a plurality of unit gap control electrodes,
two neighboring unit gap control electrodes are spaced apart from each other, and
each of the unit gap control electrodes overlaps the gap between two corresponding unit liquid crystal control electrodes.

12. The parallax barrier for the 3D image display of claim 11, wherein
a voltage applied to a portion of the unit gap control electrodes is substantially the same as a voltage applied to the opposing electrode.

13. The parallax barrier for the 3D image display of claim 10, wherein
the opposing electrode includes a plurality of unit opposing electrodes,
two neighboring unit opposing electrodes are spaced apart from each other with a gap, and
each of the opposing electrodes overlaps both of two corresponding neighboring unit liquid crystal control electrodes.

14. The parallax barrier for the 3D image display of claim 13, further comprising:
a second gap control electrode disposed between the second substrate and the opposing electrode.

15. The parallax barrier for the 3D image display of claim 14, wherein
at least a portion of the second gap control electrode and at least portion of the unit liquid crystal control electrodes are applied with different voltages such that the block portion is formed in the liquid crystal layer corresponding to the gap between the unit opposing electrodes.

16. A display device comprising:
a parallax barrier; and
a display panel,
wherein the parallax barrier comprises:
a first substrate;
a second substrate opposite to the first substrate;
a first gap control electrode disposed on the first substrate;
a first passivation layer disposed on the first the gap control electrode;
a liquid crystal control electrode disposed on the first passivation layer;
an opposing electrode disposed on the second substrate; and
a liquid crystal layer interposed between the first substrate and the second substrate,
wherein the liquid crystal control electrode includes a plurality of unit liquid crystal control electrodes,
wherein two neighboring unit liquid crystal control electrodes are spaced apart with a gap, and
wherein the first gap control electrode overlaps the gap between the unit liquid crystal control electrodes.

17. The display device of claim 16, wherein
at least a portion of first gap control electrodes and at least a portion of opposing electrodes are applied with different voltages to form a block portion in the liquid crystal layer corresponding to the gap between the unit liquid crystal control electrodes.

18. The display device of claim 17, wherein
the first gap control electrode includes a plurality of unit gap control electrodes,
two neighboring unit gap control electrodes are spaced apart from each other, and
each of the plurality of unit gap control electrodes overlaps the gap between two corresponding unit liquid crystal control electrodes.

19. The display device of claim 18, wherein
a voltage applied to a portion of the unit gap control electrodes is substantially the same as a voltage applied to the opposing electrode.

20. The display device of claim 19, wherein
the opposing electrode includes a plurality of unit opposing electrodes,
two neighboring unit opposing electrodes are spaced apart from each other, and
each of the unit opposing electrodes overlaps both of two corresponding unit liquid crystal control electrodes.
